(19) United States
(12) Patent Application Publication
(10) Pub. No.: US 2003/0124038 A1
(43) Pub. Date: Jul. 3, 2003

(54) Reactive distillation

(75) Inventors: Peter Moritz, Winterthur (CH); Willem Wiekert Levering, Winterthur (CH); Raymond Charles Pluss, Kleinandelfingen (CH)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Sulzer Chemtech AG, Winterthur (CH)

(21) Appl. No.: 10/348,801

(22) Filed: Jan. 21, 2003

Related U.S. Application Data
(62) Division of application No. 09/458,296, filed on Dec. 10, 1999.

(30) Foreign Application Priority Data
Dec. 22, 1998 (EP) 98811254.6

(51) Int. Cl. B01J 8/02; B01J 8/04

(52) U.S. Cl. 422/211; 422/190; 422/222

(57) ABSTRACT

The reactive distillation is carried out in a column (1) with a packing (2) which is at least partly designed as a catalyst carrier (23). Fluids (3, 4) which form two phases of different densities flow through the packing. An internal volume flow (300) is set for the denser fluid (3), the value of which lies in an interval (I) about a distinguished value (a), with this value being associated with a dwell time distribution (32) of the denser fluid: For the distinguished value the variance (s) of the dwell time distribution—as a function of the internal volume flow—takes on a minimum; and at the boundaries of the named interval the internal volume flow does not differ from the distinguished value by more than 30%, preferably by more than 10%.

### BACKGROUND OF THE INVENTION

The invention relates to a reactive distillation to uses of the reactive distillation, and to a packing column for carrying out the reactive distillation.

By reactive distillation is meant a process in which catalytic reactions are carried out in a column in the presence of a simultaneous distillation. In this the column can be operated as a packing column. The packing of the column typically comprises a large number of partial spaces containing solids and cavities between the partial spaces, with the cavities and the partial spaces extending largely along a column axis or at angles to the latter and the partial spaces being formed in each case by a packed bed which contains catalytically active substances. A denser fluid flows in the packed bed partial spaces with a volume flow which is designated as the internal volume flow. A less dense fluid flows in counterflow through the cavities. The packed bed partial spaces are bounded by walls which are permeable for the fluids. On the one hand, catalytic reactions take place in the packed bed and, on the other hand, a material exchange between the two fluids takes place.

Undesirable by-products arise in the reactive distillation, the concentrations of which depend on the operating parameters. As a rule a treatment of the product is required, which is the more complicated and expensive the more there are by-products which arise. The operating parameters are therefore advantageously chosen in such a manner that a production of by-products turns out to be as low as possible. However, as large a production rate of the reactive distillation to be performed as possible per unit volume of the packing is also aimed for. In order to achieve this it must be provided for that the entire packing surface, which is potentially available for the reaction, is covered (wetted) by the more dense fluid. A reactive distillation is known from U.S. Pat. No. 5,120,403 in which the packing is “flooded” with a liquid phase and a gas phase forms a foam with the liquid phase which is transported through the packing.

### SUMMARY OF THE INVENTION

It is an object of the invention to provide a further method for carrying out a reactive distillation for which the production of by-products is a minimum or at least lies in the vicinity of a possible minimum and for which the production rate of the products to be produced is as great as possible.

The reactive distillation is carried out in a column with a packing which is at least partly formed as a catalyst carrier. Fluids which form two phases of different densities flow through the packing. An internal volume flow is set for the denser fluid, the value of which lies in an interval about a distinguished value, with this value being associated with a dwell time distribution of the denser fluid: For the distinguished value the variance of the dwell time distribution—as a function of the internal volume flow—takes on a minimum; and at the boundaries of the named interval the internal volume flow differs from the distinguished value by not more than 30%, preferably by not more than 10%.

In the following the invention will be described with reference to the drawings.

### BRIEF DESCRIPTION OF THE DRAWINGS

FIG. 1 shows the lower part of a column by means of which a reactive distillation can be carried out,

FIG. 2 shows partially a packing for carrying out the reactive distillation,

FIG. 3 is a diagram for the explanation of a dwell time distribution,

FIG. 4 is an experimentally determined curve which illustrates the dependence of the variance of the dwell time distribution on the internal volume flow,

FIG. 5 shows wall sections of a cushion-like packing part,

FIG. 6 shows a carrier structure with a cylindrical packing part, and

FIG. 7 shows partially a packing with two kinds of packing structures.

### DESCRIPTION OF THE PREFERRED EMBODIMENTS

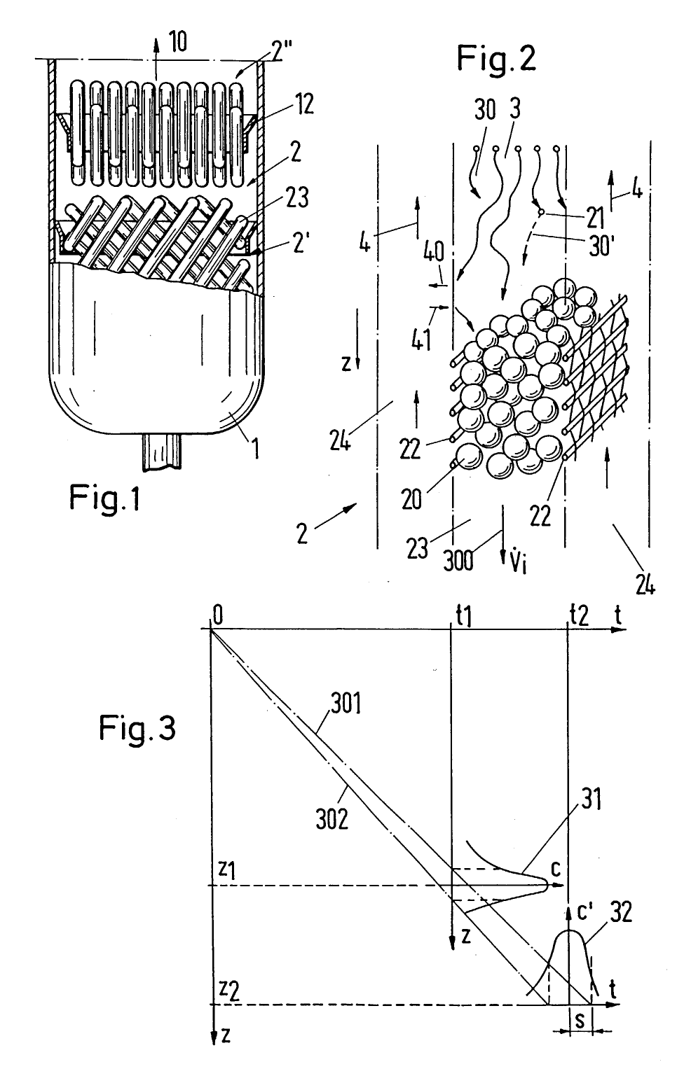

The column 1 of FIG. 1 contains a packing 2 such as is known from patent specification EP 0 640 385. The packing 2 comprises packing elements 2′ which are arranged in a stack-like manner and which are built up of layers 2″ which are directed along a main flow direction 10, with the layers 2″ being formed of substantially cylindrical packing parts 23. Between the packing parts 23 there are flow passages which cross one another and which are open with respect to one another. The packing parts 23 are laid into a grid-like carrier structure, which is not illustrated in FIG. 1. Adjacent packing elements 2′ are in each case mutually displaced by an angle of 90°. Collars 12 form deflecting obstacles for the fluids 3 and 4 which participate in the reactive distillation (see FIG. 2).

Aspects of the reactive distillation which are required for the explanation of the invention will now be explained with reference to FIGS. 2 and 3. The fluids 3 and 4, which form two phases of different densities, flow through the packing 2 in counter-flow in the direction of the z axis, which is parallel to a column axis. The packing 2 comprises cavities 24 and partial spaces 23a which extend largely along the column axis or which can also be oriented at angles to the column axis. The partial spaces 23a form in each case a packed bed 20, in particular a poured body of a granulate which is a carrier of catalytically active substances. The partial spaces 23a are bounded by walls 22 which are permeable for the fluids 3, 4. These walls 22 can for example be manufactured of wire grids (in the form of cloths, meshes or webs).

The fluid 3 flows with an internal volume flow 300 through the packed bed 20. Arrows 30 indicate paths on which molecules of the substances which are contained in the fluid 3 move. Through reactions at points 21 (inside the packed bed 20) initial substances are converted into desired products or undesirable by-products (arrow 30). A material exchange takes place (arrows 40, 41) between the fluids 3 and 4 at the surfaces of the packed bed 20 which are formed by the walls 22. A distillation can be carried out by means of this material exchange.

The molecules which are contained in the fluid 3 have different dwell times in the packed bed 20. A molecule which is brought into the packed bed 20 at the point z=0 and at the time t=0—see the diagram of FIG. 3—is located in the vicinity of a point with z=z₁ at a later time point t=t₁. The two chain-dotted lines 301 and 302 indicate a scattering region of the paths on which the molecules move through the packed bed 20. A frequency distribution of the locations z of the molecules at the time point t=t₁ is given by a bell-shaped curve 31, which is illustrated qualitatively as a function curve c=c(z; t=t₁). If one records at the lower end of the packed bed 20—namely at z=Z₂—the emergence of marked molecules which were all introduced simultaneously at the time point t=0 into the packed bed 20, then one obtains a bell-shaped curve 32: c′=c′(t; z=Z₂). For this curve 32 a variance “s” can be determined. This variance s depends on the internal volume flow 300. The marked molecules can for example be ions, the concentration of which can be determined at the packed bed end z=Z₂ as a result of measurements of the electrical conductivity.

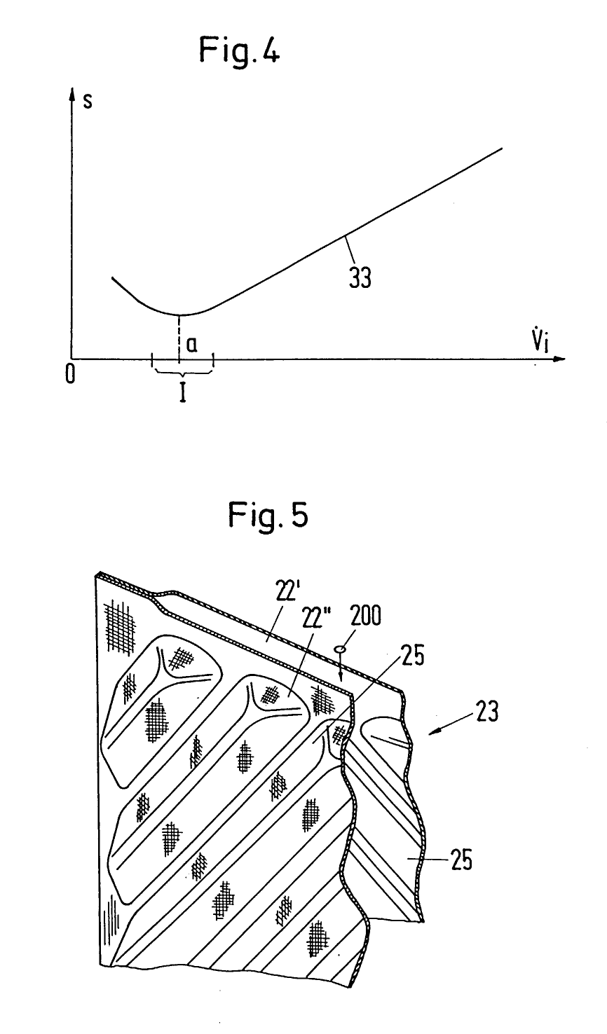

Measurements of the variance “s” in dependence on the internal volume flow 300 yield a curve 33 which has a minimum: see FIG. 4. A distinguished value “a” of the internal volume flow at which the produced amount of by-products is likewise a minimum corresponds to the minimum of “s”. At a much smaller internal volume flow than “a”, a stagnation of the fluid 3 arises in the packed bed 20 and thus partially higher dwell times arise, which has as a result a broadening of the curve 32 and thus an increase of the variance “s”. In a much larger internal volume flow than “a”, a liquid bypass arises at the surface of the packed bed 20 which is formed by the walls 22. This liquid flows past the catalytically active packed bed 20 and comes into very little contact with it. The fluid 3 has partly higher dwell times, which likewise leads to a broadening of the curve 32 and to an increase of the variance “s”.

For a predetermined production rate of the reactive distillation to be carried out an ideal process results when the column is dimensioned in such a manner that the internal volume flow takes on the distinguished value a. Deviations from this value “a” which lie in a restricted interval I about the value “a” yield no substantial worsening of the method: At the boundaries of this interval I the internal volume flow may differ from the distinguished value “a” by up to about 30%. It is of course preferable that the difference amounts to 10% or less.

A further suitable packing for carrying out the reactive distillation is known from the patent specification EP 0 631 813. Packing parts 23 which form parallel layers are formed in the shape of cushions and comprise two fluid-permeable walls 22′ and 22″: see FIG. 5. The inner space of the packing part 23 contains a granulate 200 with catalytically active substances. Parallel passages 25 in the walls 22′ and 22″, which are profiled in the manner of reliefs, form the inner space. These passages 25 cross one another and are open with respect to one another. At the edge of the packing part 23 they are closed off. As a result of the profiling of the walls 22′ and 22″, passage-like cavities likewise also result in each case between adjacent layers which cross one another and are open with respect to one another.

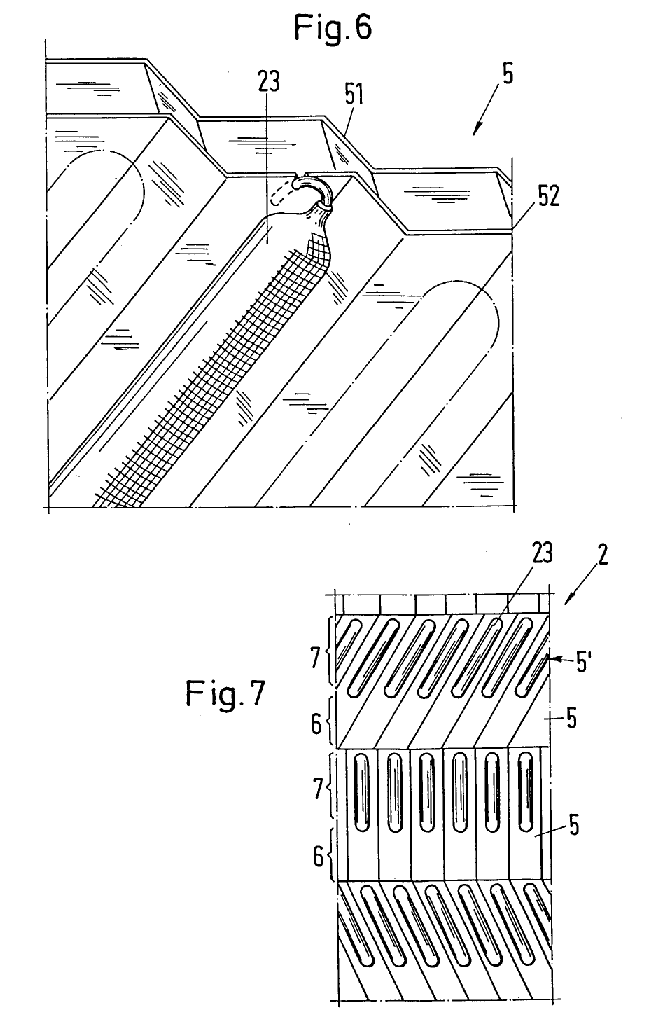

FIG. 6 shows a further suitable packing, which is known from the already named EP 0 640 385. A static mixer or packing structure 5 of surfaces 51 and 52 which are folded in a zigzag manner is used as a carrier structure for the packing parts 23. All or else only individual passages which are formed by the zigzag folding can in each case contain a packing part 23. As a rule a film of the denser fluid also forms on the carrier structure 5. Through this the surface which is available for the distillation is increased.

In order to make an even greater surface available for the distillation, the packing 2 can be designed in the following manner: see FIG. 7. In the column, zones 6 and 7 of a first and a second kind are arranged in an alternating sequence in the direction of the column axis. In the zones 6 of the first kind are contained packing structures 5 (cf. FIG. 6) in which merely a material exchange between the two fluids takes place. In the zones 7 of the second kind are contained packing structures 5′, 23 in which the reactive distillation takes place. The lengths of the zones 6 and 7 can be varied in order to make available surfaces of different size.

A production amount of the reactive distillation is predetermined for the packing column. The capacity of the column packing must be designed in accordance with the invention in such a manner that the internal volume flow which is provided for the operation of the column corresponds, on the one hand, largely to the predetermined production amount and lies, on the other hand, in the named interval I about the distinguished value a.

The reactive distillation in accordance with the invention can for example be used for the production or for the decomposition of esters, ethers and alcohols. Other uses can be the selective hydration of olefins or aromatic compounds; furthermore the carrying out of isomerisations.

An example for the explanation of the reactive distillation in accordance with the invention:

The synthesis of methyl-tert.-butyl ether (MTBE) can be carried out in a reactive distillation with catalytically active packings (cf. EP-A 0 396 650). In this, isobutene is converted to MTBE from a C4 flow with methanol. Acidic ion exchange resin can be used in this as a catalyst. In addition to the main reaction three side reactions can mainly occur. On the one hand, the C4 flow can contain traces of water, with which isobutene reacts to form tert.-butanol. On the other hand, isobutene can react with itself to form diisobutene; furthermore the condensation of methanol to dimethyl ether can take place. The two last named side reactions arise in the event of a large surplus of one reaction partner or in the absence of the other reaction partner.

In a reactive distillation which is operated with catalytically active packings, with a small internal volume flow there arise a stagnation of the liquid phase and thereby partially higher dwell times in the reaction zone of the column at different locations. In these stagnant zones the named side reactions occur to an increased extent in the event of a surplus of one reaction partner or in an absence of the other reaction partner which is caused by the reaction. In the event of an internal volume flow which exceeds the upper limit of the interval I, stagnant zones are admittedly likewise avoided, but the reaction turnover decreases considerably however.

In the reactive distillation in accordance with the invention the internal volume flow of the column is set in such a manner that the catalytically active solid is flowed through uniformly by the fluid phase and stagnant zones are avoided in the catalytically active solid bed. The catalyst is thereby completely wetted and the named side reactions are partly suppressed.

Reactive distillation

The invention relates to a reactive distillation in accordance with the preamble of claim 1, to uses of the reactive distillation and to a packing column for carrying out the reactive distillation.

By reactive distillation is meant a process in which catalytic reactions are carried out in a column in the presence of a simultaneous distillation. In this the column can be operated as a packing column. The packing of the column typically comprises a large number of partial spaces containing solids and cavities between the partial spaces, with the cavities and the partial spaces extending largely along a column axis or at angles to the latter and the partial spaces being formed in each case by a packed bed which contains catalytically active substances. A denser fluid flows in the packed bed partial spaces with a volume flow which is designated as the internal volume flow. A less dense fluid flows in counterflow through the cavities. The packed bed partial spaces are bounded by walls which are permeable for the fluids. On the one hand, catalytic reactions take place in the packed bed and, on the other hand, a material exchange between the two fluids takes place.

Undesirable by-products arise in the reactive distillation, the concentrations of which depend on the operating parameters. As a rule a treatment of the product is required, which is the more complicated and expensive the more there are by-products which arise. The operating parameters are therefore advantageously chosen in such a manner that a production of by-products turns out to be as low as possible. However, as large a production rate of the reactive distillation to be performed as possible per unit volume of the packing is also aimed for. In order to achieve this it must be provided for that the entire packing surface, which is potentially available for the reaction, is covered (wetted) by the more dense fluid. A reactive distillation is known from U.S. Pat. No. 5,120 403 in which the packing is “flooded” with a liquid phase and a gas phase forms a foam with the liquid phase which is transported through the packing.

The object of the invention is to provide a further method for carrying out a reactive distillation for which the production of by-products is a minimum or at least lies in the vicinity of a possible minimum and for which the production rate of the products to be produced is as great as possible. This object is satisfied by the reactive distillation which is characterised in claim 1.

The reactive distillation is carried out in a column with a packing which is at least partly formed as a catalyst carrier. Fluids which form two phases of different densities flow through the packing. An internal volume flow is set for the denser fluid, the value of which lies in an interval about a distinguished value, with this value being associated with a dwell time distribution of the denser fluid: For the distinguished value the variance of the dwell time distribution—as a function of the internal volume flow—takes on a minimum; and at the boundaries of the named interval the internal volume flow differs from the distinguished value by not more than 30%, preferably by not more than 10%.

The subordinate claims relate to advantageous embodiments of the invention. The subject of claim 8 is a use of the method in accordance with the invention. claim 9 is directed to a corresponding packing column.

In the following the invention will be described with reference to the drawings. Shown are:

FIG. 1 the lower part of a column by means of which a reactive distillation can be carried out,

FIG. 2 partially a packing for carrying out the reactive distillation,

FIG. 3 a diagram for the explanation of a dwell time distribution,

FIG. 4 an experimentally determined curve which illustrates the dependence of the variance of the dwell time distribution on the internal volume flow,

FIG. 5 wall sections of a cushion-like packing part,

FIG. 6 a carrier structure with a cylindrical packing part and

FIG. 7 partially a packing with two kinds of packing structures.

The column 1 of FIG. 1 contains a packing 2 such as is known from patent specification EP 0 640 385 (=P.6592). The packing 2 comprises packing elements 2′ which are arranged in a stack-like manner and which are built up of layers 2″ which are directed along a main flow direction 10, with the layers 2″ being formed of substantially cylindrical packing parts 23. Between the packing parts 23 there are flow passages which cross one another and which are open with respect to one another. The packing parts 23 are laid into a grid-like carrier structure, which is not illustrated in FIG. 1. Adjacent packing elements 2′ are in each case mutually displaced by an angle of 90°. Collars 12 form deflecting obstacles for the fluids 3 and 4 which participate in the reactive distillation (see FIG. 2).

Aspects of the reactive distillation which are required for the explanation of the invention will now be explained with reference to FIGS. 2 and 3. The fluids 3 and 4, which form two phases of different densities, flow through the packing 2 in counter-flow in the direction of the z axis, which is parallel to a column axis. The packing 2 comprises cavities 24 and partial spaces 23 which extend largely along the column axis or which can also be oriented at angles to the column axis. The partial spaces 23 form in each case a packed bed 20, in particular a poured body of a granulate which is a carrier of catalytically active substances. The partial spaces 23 are bounded by walls 22 which are permeable for the fluids 3, 4. These walls 22 can for example be manufactured of wire grids (in the form of cloths, meshes or webs).

The fluid 3 flows with an internal volume flow 300 through the packed bed 22. Arrows 30 indicate paths on which molecules of the substances which are contained in the fluid 3 move. Through reactions at points 21 (inside the packed bed 20) initial substances are converted into desired products or undesirable by-products (arrow 30′). A material exchange takes place (arrows 40, 41) between the fluids 3 and 4 at the surfaces of the packed bed 20 which are formed by the walls 22. A distillation can be carried out by means of this material exchange.

The molecules which are contained in the fluid 3 have different dwell times in the packed bed 20. A molecule which is brought into the packed bed 20 at the point z=0 and at the time t=0—see the diagram of FIG. 3—is located in the vicinity of a point with z=z₁ at a later time point t=t₁. The two chain dotted lines 301 and 302 indicate a scattering region of the paths on which the molecules move through the packed bed 20. A frequency distribution of the locations z of the molecules at the time point t=t₁ is given by a bell shaped curve 31, which is illustrated qualitatively as a function curve c=c(z; t=t₁). If one records at the lower end of the packed bed 20—namely at z=Z₂ —the emergence of marked molecules which were all introduced simultaneously at the time point t=0 into the packed bed 20, then one obtains a bell shaped curve 32: c′=c′(t; z=Z₂). For this curve 32 a variance s can be determined. This variance s depends on the internal volume flow 300. The marked molecules can for example be ions, the concentration of which can be determined at the packed bed end z=Z₂ as a result of measurements of the electrical conductivity.

Measurements of the variance s in dependence on the internal volume flow 300 yield a curve 33 which has a minimum: see FIG. 4. A distinguished value a of the internal volume flow at which the produced amount of by-products is likewise a minimum corresponds to the minimum of s. At a much smaller internal volume flow than a, a stagnation of the fluid 3 arises in the packed bed 20 and thus partially higher dwell times arise, which has as a result a broadening of the curve 32 and thus an increase of the variance s. In a much larger internal volume flow than a, a liquid bypass arises at the surface of the packed bed 20 which is formed by the walls 22. This liquid flows past the catalytically active packed bed 20 and comes into very little contact with it. The fluid 3 has partly higher dwell times, which likewise leads to a broadening of the curve 32 and to an increase of the variance s.

For a predetermined production rate of the reactive distillation to be carried out an ideal process results when the column is dimensioned in such a manner that the internal volume flow takes on the distinguished value a. Deviations from this value a which lie in a restricted interval I about the value a yield no substantial worsening of the method: At the boundaries of this interval I the internal volume flow may differ from the distinguished value a by up to about 30%. It is of course preferable that the difference amounts to 10% or less.

A further suitable packing for carrying out the reactive distillation is known from the patent specification EP 0 631 813 (=P.6579). Packing parts 23 which form parallel layers are formed in the shape of cushions and comprise two fluid-permeable walls 22′ and 22″: see FIG. 5. The inner space of the packing part 23 contains a granulate 200 with catalytically active substances. Parallel passages 25 in the walls 22′ and 22″, which are profiled in the manner of reliefs, form the inner space. These passages 25 cross one another and are open with respect to one another. At the edge of the packing part 23 they are closed off. As a result of the profiling of the walls 22′ and 22″, passage-like cavities likewise also result in each case between adjacent layers which cross one another and are open with respect to one another.

FIG. 6 shows a further suitable packing, which is known from the already named EP 0 640 385. A static mixer structure 5 of surfaces 51 and 52 which are folded in a zigzag manner is used as a carrier structure for the packing parts 23. All or else only individual passages which are formed by the zigzag folding can in each case contain a packing part 23. As a rule a film of the denser fluid also forms on the carrier structure 5. Through this the surface which is available for the distillation is increased.

In order to make an even greater surface available for the distillation, the packing 2 can be designed in the following manner: see FIG. 7. In the column, zones 6 and 7 of a first and a second kind are arranged in an alternating sequence in the direction of the column axis. In the zones 6 of the first kind are contained packing structures 5 (cf. FIG. 6) in which merely a material exchange between the two fluids takes place. In the zones 7 of the second kind are contained packing structures 5′, 23 in which the reactive distillation takes place. The lengths of the zones 6 and 7 can be varied in order to make available surfaces of different size.

A production amount of the reactive distillation is predetermined for the packing column. The capacity of the column packing must in accordance with the invention be designed in such a manner that the internal volume flow which is provided for the operation of the column corresponds, on the one hand, largely to the predetermined production amount and lies, on the other hand, in the named interval I about the distinguished value a.

The reactive distillation in accordance with the invention can for example be used for the production or for the decomposition of esters, ethers and alcohols. Other uses can be the selective hydration of olefins or aromatic compounds; furthermore the carrying out of isomerisations. An example for the explanation of the reactive distillation in accordance with the invention:

The synthesis of methyl-tert.-butyl ether (MTBE) can be carried out in a reactive distillation with catalytically active packings (cf. EP-A 0 396 650). In this, isobutene is converted to MTBE from a C4 flow with methanol. Acidic ion exchange resin can be used in this as a catalyst. In addition to the main reaction three side reactions can mainly occur. On the one hand, the C4 flow can contain traces of water, with which isobutene reacts to form tert.-butanol. On the other hand, isobutene can react with itself to form diisobutene; furthermore the condensation of methanol to dimethyl ether can take place. The two last named side reactions arise in the event of a large surplus of one reaction partner or in the absence of the other reaction partner.

In a reactive distillation which is operated with catalytically active packings, with a small internal volume flow there arise a stagnation of the liquid phase and thereby partially higher dwell times in the reaction zone of the column at different locations. In these stagnant zones the named side reactions occur to an increased extent in the event of a surplus of one reaction partner or in an absence of the other reaction partner which is caused by the reaction. In the event of an internal volume flow which exceeds the upper limit of the interval I, stagnant zones are admittedly likewise avoided, but the reaction turnover decreases considerably however.

In the reactive distillation in accordance with the invention the internal volume flow of the column is set in such a manner that the catalytically active solid is flowed through uniformly by the fluid phase and stagnant zones are avoided in the catalytically active solid bed. The catalyst is thereby completely wetted and the named side reactions are partly suppressed.

1. Reactive distillation in a column (1) comprising a packing (2) which is at least partly designed as a catalyst carrier (23), with fluids (3, 4) which form two phases of different densities flowing through the packing,
characterised in that an internal volume flow (300) is set for the denser fluid (3), the value of which lies in an interval (I) about a distinguished value (a) which is associated with a dwell time distribution (32) of the denser fluid; in that for this distinguished value the variance (s) of the dwell time distribution—as a function of the internal volume flow—takes on a minimum; and in that at the boundaries of the named interval the internal volume flow does not differ from the distinguished value by more than 30%, preferably 10%.

2. Reactive distillation in accordance with claim 1, characterised in that the column (1) contains a packing (2) which comprises a large number of partial spaces (23) containing solid substances and cavities (24) between the named partial spaces, with the cavities extending largely along a column axis or at angles to the latter, with the named partial spaces in each case being formed by a packed bed which contains catalytically active substances and with these packed bed partial spaces being bounded by walls (22) which are permeable for the fluids (3, 4).

3. Reactive distillation in accordance with claim 2, characterised in that zones (6, 7) of a first and of a second kind are arranged in the column (1) in an alternating succession in the direction of the column axis, with packing structures (5) in which merely a material exchange between the two fluids takes place being contained in the zones of the first kind, whereas packing structures (5′) in which the reactive distillation is carried out are contained in the zones of the second kind.

4. Reactive distillation in accordance with claim 2 or claim 3, characterised in that the packing (2) or the packing structures (5′) which are provided for carrying out the reactive distillation are built up of layers which are oriented in the direction of the column axis; and in that adjacent layers in each case form passage-like cavities which cross one another and are open with respect to one another.

5. Reactive distillation in accordance with claim 4, characterised in that the layers are in each case formed by a plurality of packing parts (23) containing catalytically active substances which are laid into a carrier structure (5); and in that the packing parts are substantially cylindrical.

6. Reactive distillation in accordance with claim 4, characterised in that the layers are in each case formed by cushion-like packing parts (23) which comprise two fluid-permeable walls; and in that the inner spaces of the packing parts are formed by parallel passages containing catalytically active substances (200) which are present in the form of a relief-like profiling of the walls (25), with these passages crossing one another, being open with respect to one another and being closed off at the edge of the packing part.

7. Use of the reactive distillation in accordance with one of the claims 1 to 6 for the manufacture or for the decomposition of esters, ethers or alcohols.

8. Use of the reactive distillation in accordance with one of the claims 1 to 6 for the selective hydration of olefins or aromatic compounds.

9. Use of the reactive distillation in accordance with one of the claims 1 to 6 for carrying out isomerisations.

10. Packing column (1) for carrying out a reactive distillation in accordance with one of the claims 1 to 6, characterised in that a production amount is predetermined for the reactive distillation; and in that the capacity of the column packing is designed in such a manner that the internal volume flow (300) which is predetermined for the operation of the column corresponds, on the one hand, largely to the predetermined production amount and lies, on the other hand, in the named interval (I) about the distinguished value (a).
